(19) United States
(12) Patent Application Publication
(10) Pub. No.: US 2013/0155669 A1
(43) Pub. Date: Jun. 20, 2013

(54) Separate Drive Circuit Structure for LED Lamp Tube

(71) Applicants: Feng-Pin LEE, Jhubei City (TW); Chun-Chen Liu, Jhubei City (TW); Yu-Kuan Chang, Jhubei City (TW)

(72) Inventors: Feng-Pin LEE, Jhubei City (TW); Chun-Chen Liu, Jhubei City (TW); Yu-Kuan Chang, Jhubei City (TW)

(21) Appl. No.: 13/597,767

(22) Filed: Aug. 29, 2012

(30) Foreign Application Priority Data
Dec. 14, 2011 (TW) 100223586

(51) Int. Cl. F21V 1/00

(52) U.S. Cl. 362/223

(57) ABSTRACT

A separate drive circuit structure for light emitting diode (LED) lamp tube, wherein the LED lamp tube comprises a lampshade and at least an LED lamp strap installed inside the lampshade, and the left and right sides of the LED lamp strap in the interior of the lampshade are respectively installed with a separate drive circuit structure. The separate drive circuit structures disposed at the two ends are connected with a transmission line such that the separate drive circuit structures disposed at the two ends together constitute a drive circuit capable of driving the LED lamp strap to illuminate. Moreover, the separate drive circuit structure can effectively reduce the tube diameter of the lampshade.

The current application claims a foreign priority to the patent application of Taiwan No. 100223586 filed on Dec. 14, 2011.

### BACKGROUND OF THE INVENTION

1. Field of the Invention

The present invention generally relates to a separate drive circuit structure for light emitting diode (LED) lamp tube; in particular, the present invention relates to a separate drive circuit structure respectively installed at the two ends of the LED lamp strap inside an LED lamp tube, in which the separate drive circuit structures disposed at both the left and right ends conjunctively form a drive circuit in order to drive the LED lamp strap for light emissions.

2. Description of Related Art

Featuring many advantages such as better power saving, longer life span, smaller size and faster reaction speed or the like, light emitting diodes (LEDs) are at present comprehensively applied in various illumination fields. Now certain manufacturers have developed the LED lamp tube allowable for replacement of fluorescent lamps. A conventional LED lamp tube is installed with two LED lamp straps inside the long-strapped lampshade, and a drive circuit structure connected with the LED lamp strap is respectively installed on the two sides of the interior of the long-strapped lampshade in order to drive the LED lamp strap to illuminate with the two ends.

In addition to the two-ended drive structure as described above, there are also companies developing a type of LED lamp tube 1 characterizing in single-ended driving for a single LED lamp strap illumination. As shown in FIGS. 1 and 2, some manufacturers attempted to place only one longer LED lamp strap 12 inside the long-strapped lampshade 11, while this LED lamp strap 12 is also driven by a drive circuit 13 for illumination of the LED lamp 121. However, to drive the longer LED lamp strap 12, such an implementation may require more components and greater size on the drive circuit 13, thus leading to increased tube diameter of the long-strapped lampshade 11 so as to accommodate the drive circuit 13 inside the long-strapped lampshade 11, but this tube diameter enlargement in the long-strapped lampshade 11 may also result in higher manufacture costs.

Therefore, it would an optimal solution if it is possible to divide the drive circuit structure into two blocks respectively installed on the left and the right sides inside the long-strapped lampshade so that the accommodation space occupied by the drive circuit can be reduced and the tube diameter of the long-strapped lampshade can be also lessened thereby successfully minimizing the lamp tube.

### SUMMARY OF THE INVENTION

The present invention provides a drive circuit structure respectively installed at the two ends of an LED lamp strap, and the drive circuit structures disposed at the left and right ends conjunctively form a drive circuit in order to drive the LED lamp strap to illuminate.

A separate drive circuit structure for light emitting diode (LED) lamp tube according to the present invention can achieve the aforementioned objectives, wherein the LED lamp tube comprises a lampshade and at least an LED lamp strap installed inside the lampshade. Herein the left and right sides of the LED lamp strap in the interior of the lampshade are respectively installed with a separate drive circuit structure, and the separate drive circuit structures disposed at the two ends are connected with a transmission line such that the separate drive circuit structures disposed at the two ends together constitute a drive circuit capable of driving the LED lamp strap to illuminate. Moreover, the separate drive circuit structure can effectively reduce the tube diameter of the lampshade.

More specifically, the aforementioned LED lamp strap includes a plurality of LEDs.

More specifically, the aforementioned lampshade is of a long-strapped shape.

More specifically, the aforementioned separate drive circuit structures disposed at the two ends are connected with a transmission line to constitute a complete drive circuit structure, and the complete drive circuit structure comprises an EMI filter circuit module, a rectifying circuit module, an LED control circuit module, and other circuit modules for driving the LED lamp strap, in which the LED control circuit module is connected to the LED lamp strap in order to drive the LED lamp strap to illuminate.

More specifically, one end of the aforementioned separate drive circuit structure is a combination of the EMI filter circuit module and the rectifying circuit module, and the other end thereof is a combination of the LED control circuit module and other circuit modules for driving the LED lamp strap.

### BRIEF DESCRIPTION OF THE DRAWINGS

FIG. 1 shows a structural diagram of a prior art LED lamp tube;

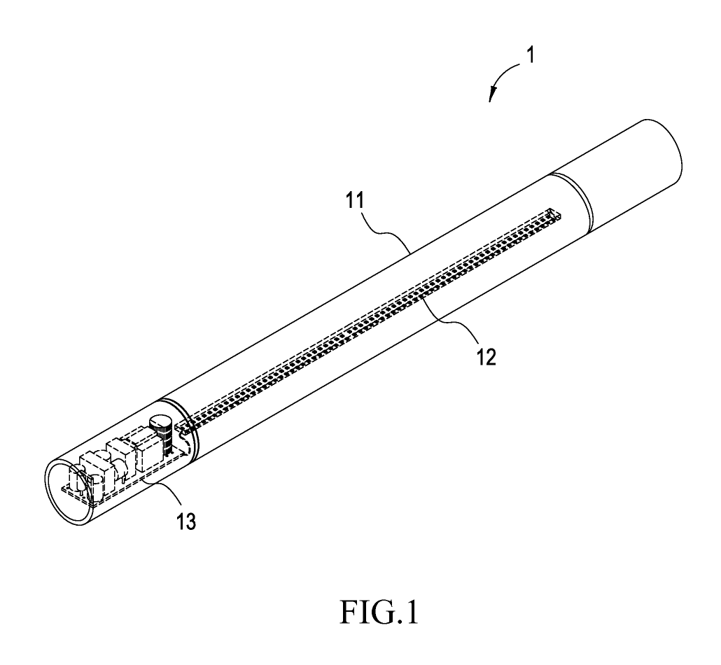

FIG. 2 shows a structural side view of a prior art LED lamp tube;

FIG. 3 shows an integral structural diagram of a separate drive circuit structure for LED lamp tube according to the present invention;

FIG. 4 shows an integral structural side view of a separate drive circuit structure for LED lamp tube according to the present invention; and

FIG. 5 shows a structural diagram for the complete drive circuit of a separate drive circuit structure for LED lamp tube according to the present invention.

### DETAILED DESCRIPTION OF THE PREFERRED EMBODIMENTS

The aforementioned and other technical contents, aspects and effects in relation with the present invention can be clearly appreciated through the detailed descriptions concerning the preferred embodiments of the present invention in conjunction with the appended drawings.

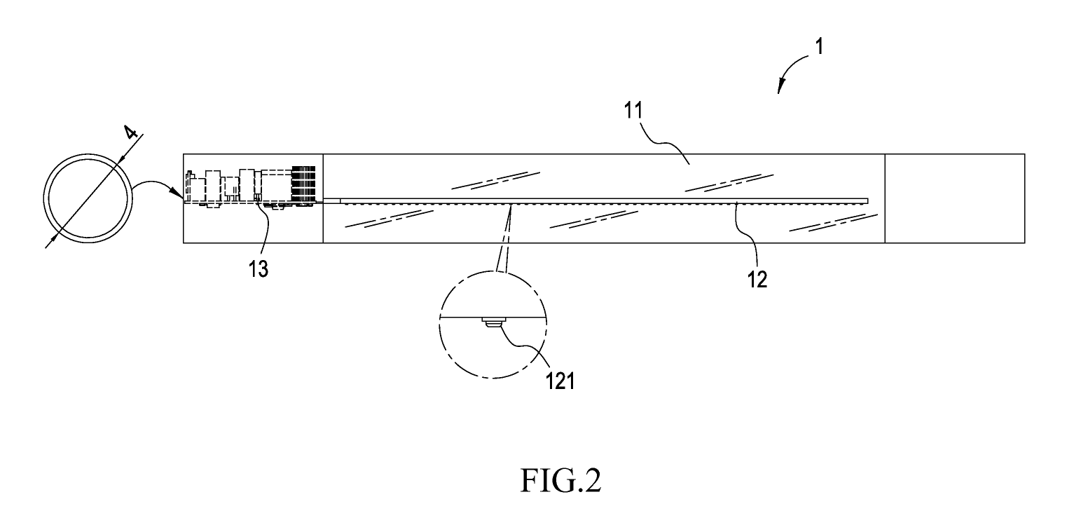

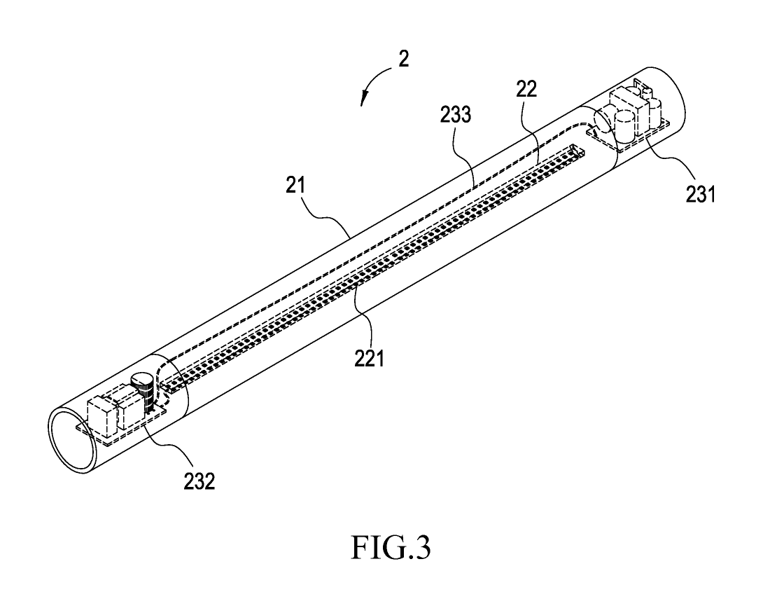

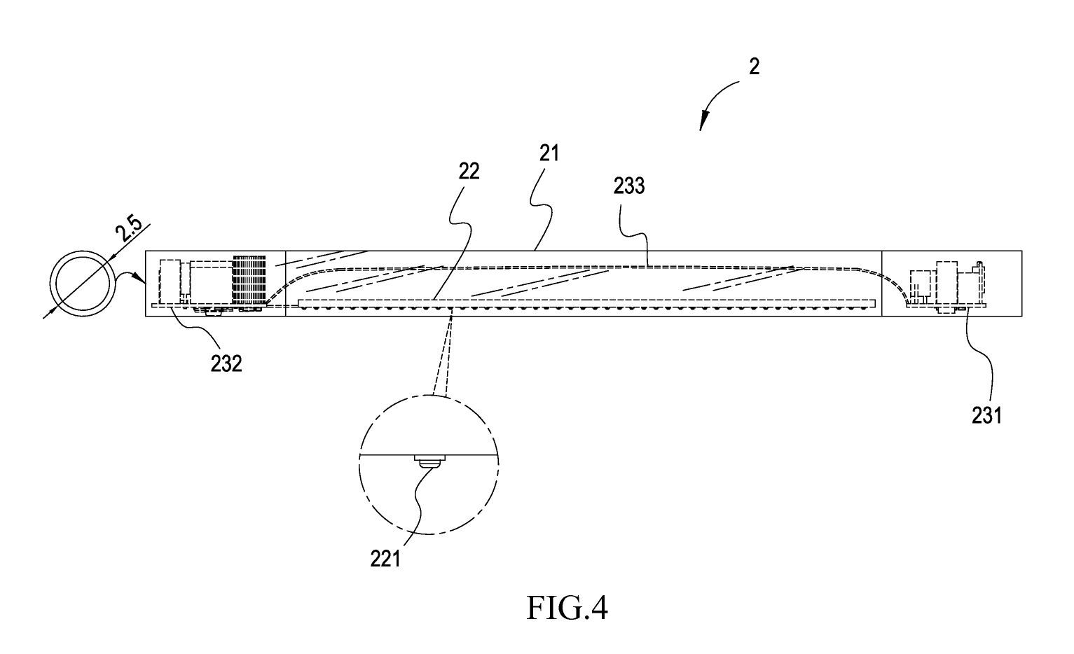

Refer first to FIGS. 3 and 4, wherein a structural diagram and a side view of a separate drive circuit structure for light emitting diode (LED) lamp tube according to the present invention are shown. It can be seen from the Figures that the LED lamp tube 2 comprises a lampshade 21 and at least an LED lamp strap 22 installed inside the lampshade 21, and the left and right sides of the LED lamp strap 22 inside the lampshade 21 are respectively installed with a separate drive circuit structure 231, 232. Since the separate drive circuit structures 231, 232 disposed at the two ends are formed by dividing a complete drive circuit structure 23 into two blocks, these separate drive circuit structures 231, 232 disposed at the two ends need to be connected with a transmission line such that the separate drive circuit structures 231, 232 disposed at the two ends can constitute a drive circuit capable of driving the LED lamp strap 22 to emit light (by comparing FIG. 2 for prior art and FIG. 4 in accordance with the present invention, it can be appreciated that this separate drive circuit structure can effectively reduce the tube diameter of the lampshade so as to achieve the lamp tube minimization).

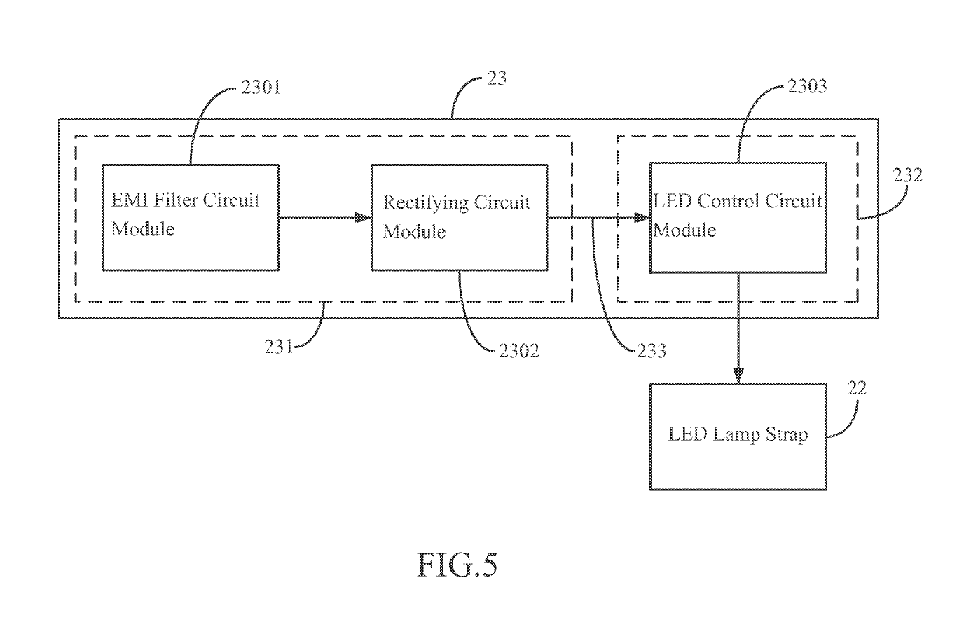

Therefore, the separate drive circuit structures 231, 232 disposed at the two ends are connected with a transmission line 233 thereby forming a complete drive circuit structure 23. Also, as shown in FIG. 5, a complete drive circuit structure 23 comprises an EMI filter circuit module 2301, a rectifying circuit module 2302, an LED control circuit module 2303, as well as other circuit modules for driving the LED lamp strap (not shown). Herein the EMI filter circuit module 2301 is applied to filter the received alternative current (AC) to remove unwanted noises, and then the rectifying circuit module 2302 converts the filtered AC signals (sinusoidal waves) to direct current (DC) signals (half-sinusoidal waves) and inputs the DC signals to the LED control circuit module 2303 connected with the LED lamp strap 22 in order to drive the LED lamp strap 22 to illuminate.

Thus, a preferred implementation for the present invention is to install the EMI filter circuit module 2301 and the rectifying circuit module 2302 to the separate drive circuit structures 231 disposed at a first end, in which the separate drive circuit structures 231 disposed at the first end is directly connected to an external AC power source, but since the LED control circuit module 2303 is not installed in the separate drive circuit structures 231 disposed at the first end, it may not be directly connected to the LED lamp strap 22.

Rather, the LED control circuit module 2303 is installed to the separate drive circuit structures 232 disposed at a second end, so the separate drive circuit structures 232 disposed at the second end will be connected to the LED lamp strap 22. Consequently, when the separate drive circuit structures 232 disposed at the second end is connected to the separate drive circuit structures 231 disposed at the first end through the transmission line 233, it is possible to input the DC signals to the LED control circuit module 2303 and provide the electric power required for illumination of the LED lamp strap 22 from the LED control circuit module 2303 so as to drive the LED lamps 221 in the LED lamp strap 22 to illuminate.

In addition to the above-said implementation, it is also possible, depending on the circuit architecture, to install the EMI filter circuit module 2301, rectifying circuit module 2302 and LED control circuit module 2303 respectively to the ends of the LED lamp tube in a different way. Whereas the only condition needed to be fulfilled is to allow constitution of a complete drive circuit structure 23 upon connecting the separate drive circuit structures 231, 232 via a transmission line 233 thereby driving the LED lamp strap 22 to light up.

Compared with other conventional technologies, the separate drive circuit structure for LED lamp tube provided by the present invention further offers the following advantages:

1. The present invention applies a transmission line to connect the separate drive circuit structures disposed at the left and right ends thereby forming a drive circuit for driving the LED lamp strap, thus achieving the objective of lamp tube diameter reduction.

2. The separate drive circuit structure disposed at two ends according to the present invention can effectively save the accommodation space for the drive circuit structure and also lower the manufacture costs of the LED lamp tube.

By way of the aforementioned detailed descriptions for the preferred embodiments according to the present invention, it is intended to better illustrate the characters and spirit of the present invention rather than restricting the scope of the present invention to the preferred embodiments disclosed in the previous texts. Contrarily, the objective is to encompass all changes and effectively equivalent arrangements within the scope of the present invention as delineated in the following claims of the present application.

What is claimed is:

1. A separate drive circuit structure for light emitting diode (LED) lamp tube, wherein the LED lamp tube comprises a lampshade and at least an LED lamp strap installed inside the lampshade, characterized in that: the left and right sides of the LED lamp strap in the interior of the lampshade are respectively installed with a separate drive circuit structure, and the separate drive circuit structures disposed at the two ends are connected with a transmission line such that the separate drive circuit structures disposed at the two ends together constitute a drive circuit capable of driving the LED lamp strap to illuminate.

2. The separate drive circuit structure for LED lamp tube according to claim 1, wherein the LED lamp strap includes a plurality of LEDs.

3. The separate drive circuit structure for LED lamp tube according to claim 1, wherein the lampshade is of a long-strapped shape.

4. The separate drive circuit structure for LED lamp tube according to claim 1, wherein the separate drive circuit structures disposed at the two ends are connected with a transmission line to constitute a complete drive circuit structure, and one end of the separate drive circuit structure is connected to the LED lamp strap in order to drive the LED lamp strap to illuminate.

5. The separate drive circuit structure for LED lamp tube according to claim 4, wherein a complete drive circuit structure comprises an EMI filter circuit module, a rectifying circuit module, an LED control circuit module, and other circuit modules for driving the LED lamp strap.

6. The separate drive circuit structure for LED lamp tube according to claim 1, wherein one end of the separate drive circuit structure is a combination of the EMI filter circuit module and the rectifying circuit module, and the other end thereof is a combination of the LED control circuit module and other circuit modules for driving the LED lamp strap.

7. The separate drive circuit structure for LED lamp tube according to claim 1, wherein the separate drive circuit structure is to selectively install the EMI filter circuit module, the rectifying circuit module and the LED control circuit module to the two ends of the LED lamp tube, and these separate drive circuit structures are connected with a transmission line thereby forming a complete drive circuit structure.
